(19) United States
(12) Patent Application Publication
(10) Pub. No.: US 2024/0160619 A1
(43) Pub. Date: May 16, 2024

(54) SOFTWARE DEFINED NETWORK STACK

(71) Applicant: VMware LLC, Palo Alto, CA (US)

(72) Inventors: Debnil Arindam Sur, San Francisco, CA (US); Benjamin L. Pfaff, Redwood City, CA (US); Leonid Ryzhyk, Sunnyvale, CA (US); Mihai-Dan Budiu, Sunnyvale, CA (US)

(21) Appl. No.: 17/985,121

(22) Filed: Nov. 10, 2022

(51) Int. Cl. G06F 16/23; G06F 16/21; G06F 16/22

(52) U.S. Cl. CPC G06F 16/2365; G06F 16/211; G06F 16/2282; G06F 16/2358

(57) ABSTRACT

Some embodiments of the invention provide a novel method for programming the management, control and data planes of a software-defined network (SDN) in a unified way. Some embodiments use a transactional database to store the management plane state, and implement the control plane with a specialized query language that, when compiled, automatically executes in an incremental fashion, which improves the scalability of the control plane. For instance, in response to a change, the controller does not re-compute and redistribute the entire network state. Instead, it performs an incremental amount of work proportional to the size of modified state, not of the entire network state. Some embodiments use Differential Datalog (DDlog) for the control plane to compute over relations and collections, and to offer automatic incremental updates. To aid correctness, some embodiments type-check together the management, control and data planes, and use automated tools to generate most code for data movement between planes.

### BACKGROUND

Software defined networking (SDN) is typically divided into three parts: the management plane, the control plane, and the data plane. The management plane handles high-level network policies, such as maintenance and monitoring, and provides APIs for administration. The control plane decides how packets are forwarded or dropped. The data plane forwards the actual data packets.

Today, these three components (the management, control, and data planes) are all separately developed. Manually written code connects the management plane's configuration to the control plane, and the control plane generates the data planes' configurations as small program fragments that scatter across the codebase. Scalability and correctness become increasing challenges as such a system develops and grows.

In recent years, software-defined networking (SDN) has broadly enabled the management of network devices, and high-speed, programmable data planes have allowed developers to define complete and arbitrary processing of individual packets. But despite these advances, it remains difficult and error-prone to program the entire network.

As shown in FIG. 1, the management plane 105 is often implemented as an application programming interface (API) 107 backed by a database 109. The control plane 110 is typically implemented as an SDN controller 112 that is at times written in an imperative language (such as Java or C++), while the data plane 115 is often built using flow-programmable switch software or hardware. Within this paradigm, adding new network features that span all three planes often decreases the confidence in overall system correctness.

This is because for such an architecture, different teams implement each plane separately with different technologies, which create two sets of issues: correctness and scalability. Correctness is a first challenge because orchestration that is needed across the different planes as well as interactions between features within a plane introduce a high level of complexity that is often very hard to maintain and debug.

For example, the SDN controller acts as a specialized compiler that converts high-level policies into small data plane program fragments, e.g. OpenFlow flows. The control plane installs fragments in network devices (e.g., switches). At any given time, a switch executes an Open-Flow program constructed from its currently installed fragments. Additional features require new flow rule fragments for tables and associated priorities. These become scattered over the controller's quickly growing code base. The controller must handle various edge cases when translating policies into these new fragments, and must ensure that any possible combination of runtime policies generates a legal OpenFlow program for the targets.

The Open Virtual Network (OVN) is a commercially deployed system for virtual network management. OVN manages a complex distributed system including an OVSDB database system and multiple Open vSwitch data planes. It provides L2/L3 virtual networking in support of many network features: logical switches and routers, security groups, L2/L3/L4 ACLs, tunnel overlays, and logical-physical gateways. However, over time, the controller's code base and the number of OpenFlow program fragments scattered through the code base grow at a similar rate, and the sprawling code base significantly hurts maintenance and network correctness.

Scalability is the second challenge: as the system grows, the SDN controller must still respond quickly to changes. In return, this demands incrementality. In response to a change, the controller should not recompute and redistribute the entire network state. Instead, the re-computation should be proportional to the amount of modified state. Today's control plane implementations scale poorly and do not perform incremental operations well.

The traditional imperative programming languages (like Java or C++) used in controllers do not support incrementality, which is essential to performance at scale. Moreover, writing an incremental controller in an imperative language would demand either an unnatural coding style or ad hoc, fragile support for incremental changes that seem important in practice. In other words, writing incremental programs by hand requires a verbose and confusing coding style (reacting to concurrent events), or ad-hoc approaches for providing incremental computation.

Consider labeling reachable nodes in a graph, a standard problem for computing forwarding tables. A full computation can be done in a couple hundred lines of Java. But an incremental Java implementation, supporting dynamic insertions and deletions of network links, and recomputing only the changed labels, is much harder. An incremental controller implementation can require several thousands of lines of code. Despite developer and quality-assurance efforts, multiple releases for debugging are often required. A controller includes many such algorithms, each of which can benefit from an incremental implementation.

Given that it is hard to write robust controllers that perform incremental operations, many controllers today re-compute and redistribute the entire network state in response to a change in the network state, which can occur often due to many classes of events: policy updates, changes in load, maintenance, link failures, etc. The re-computation and redistribution of the entire network state causes many controllers to struggle to handle data center-sized deployments.

### BRIEF SUMMARY

Some embodiments of the invention provide a novel method for programming the management, control and data planes of a software-defined network (SDN) in a unified way. Some embodiments use a transactional database to store the management plane state, and implement the control plane with a specialized query language that, when compiled, automatically executes in an incremental fashion, which improves the scalability of the control plane. For instance, in response to a change, the controller does not re-compute and redistribute the entire network state. Instead, it performs an incremental amount of work proportional to the size of modified state, not of the entire network state. This allows the control plane to handle datacenter-sized deployments. In some embodiments, the data plane is programmed through a known data plane programming language, such as P4. To aid correctness, some embodiments type-check together the management, control and data planes, and use automated tools to generate most code for data movement between planes.

Some embodiments use a general-purpose programming language that supports incremental computation of the control plane. The programming language of some embodiments computes over relations and collections, and offers automatic incremental updates. This language can be used to implement automatically incremental programs. For instance, some embodiments use Differential Datalog (DDlog), which is used today in the context of relational databases. Using the rich dialect of DDlog, a programmer can write a specification for a non-incremental program. From this description, the DDlog compiler generates an efficient incremental implementation. This implementation only processes input changes or events, and it produces only output changes instead of entire new versions of the outputs.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a management plane implemented as an application programming interface (API) backed by a database.

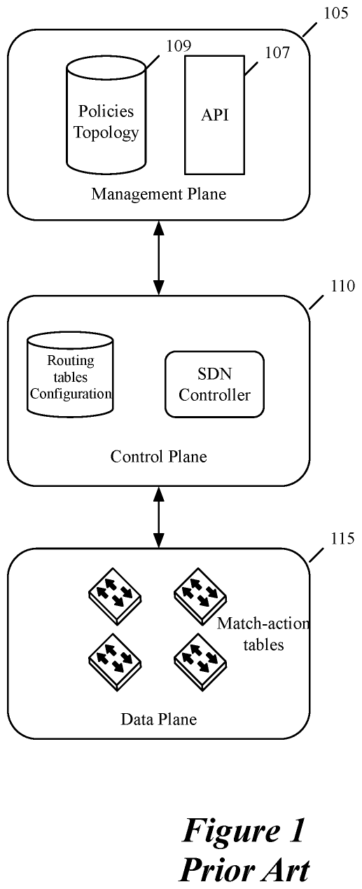

FIG. 2 illustrates an SDN stack of some embodiments of the invention.

FIG. 3 illustrates the declaration of the output relation InVlan that is generated from a P4 match-action table.

FIG. 4 illustrates the input relation Port that is generated from an OVSDB table.

FIG. 5 illustrates a DDlog rule that a programmer writes to compute the contents of the output relation from the data in the input relation.

FIG. 6 illustrates a Nerpa programming framework.

FIG. 7 illustrates an exemplary Nerpa implementation.

FIG. 8 illustrates the code snippets that implement a simplified version of the VLAN assignment feature.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a novel method for programming the management, control and data planes of a software-defined network (SDN) in a unified way. Some embodiments use a transactional database to store the management plane state, and implement the control plane with a specialized query language that, when compiled, automatically executes in an incremental fashion, which improves the scalability of the control plane. For instance, in response to a change, the controller does not re-compute and redistribute the entire network state. Instead, it performs an incremental amount of work proportional to the size of modified state, not of the entire network state. This allows the control plane to handle datacenter-sized deployments. In some embodiments, the data plane is programmed through a known data plane programming language, such as P4. To aid correctness, some embodiments type-check together the management, control and data planes, and use automated tools to generate most code for data movement between planes.

Some embodiments use a general-purpose programming language that supports incremental computation of the control plane. The programming language of some embodiments computes over relations and collections, and offers automatic incremental updates. This language can be used to implement automatically incremental programs. For instance, some embodiments use Differential Datalog (DDlog), which is used today in the context of relational databases. Using the rich dialect of DDlog, a programmer can write a specification for a non-incremental program. From this description, the DDlog compiler generates an efficient incremental implementation. This implementation only processes input changes or events, and it produces only output changes instead of entire new versions of the outputs.

Consider the following DDlog implementation of the network labeling problem:
Label(n1, label):—AssignedLabel(n1, label).
Label(n2, label):—Label(n1, label), Edge(n1, n2).
   In some embodiments, the DDlog compiler automatically generates an incremental version of a program that maintains labels for any insertions or deletions of network edges or modifications of assigned labels. A slightly refined version of this program is used in a production network controller with customers.

Some embodiments provide a unified environment for full-stack SDN programming. This environment combines relational and procedural abstractions to realize SDN's high-level approach and programmable data planes' fine-grained control. This environment is designed with the following two insights: (1) an automatically incremental control plane improves scalability, and (2) co-designing the management, control and data planes helps overall correctness.

More specifically, instead of writing and optimizing an imperative controller by hand, a network developer can write a control plane program in a modern programming language (such as DDLog) that is designed for computing over collections, which its compiler makes incremental automatically. Using such a programming language, the developer expresses network features (as logical rules) that compute forwarding rules from high-level policies. The compiler turns these logical rules into incremental programs, which compute changes to forwarding rules from changes in policies.

To co-design the management, control and data planes, some embodiments generate the types for the control plane program from the data and management planes. Tooling is automated and simplify data conversion when moving data between the planes. This saves developer time spent writing glue code and fashioning interfaces between different software components of the different planes. In some embodiments, the programming framework includes an OVSDB (Open vSwitch Database) management plane, a P4 data plane, and a DDlog control plane.

Before describing more detailed embodiments of the invention, the challenges for programming an entire network will be described. These challenges include (1) scalability issues in control planes that can be addressed through the above-described incremental approach, (2) the difficulties of building incremental networked systems, and (3) the issues raised by modern programmable data planes.

Small, frequent configuration changes happen in network deployments. Their rapid occurrence at high scale can challenge an SDN system's performance. Recomputing the state of an entire network on each change requires significant CPU resources across compute nodes and creates high control plane latency. Also, a poorly-timed configuration issue could delay subsequent jobs or cause a critical work-load to fail.

An incremental control plane can help address these challenges. It would only compute the data plane changes that correspond to configuration changes or events. This requires the operator to specify how changes in inputs are translated to changes in outputs. This approach avoids the expense of recomputing the entire network. It also reduces time spent planning for undesirable side effects and helps the operator debug those that do occur.

SDN controllers are typically written in a traditional imperative language, like Java or C++ because incremental programs are difficult to write. Making programs written with traditional imperative languages incremental can increase the amount of code by an order of magnitude. It can also create new bugs that are difficult to detect and fix, particularly at scale.

A networking-specific challenge stems from many control plane computations that require recursion or iteration. For instance, for graph reachability computations for routing tables, an SDN controller typically receives periodic updates from routers. For each update, the SDN controller updates the network topology graphs and computes a form of all-pairs shortest-path with constraints imposed by routing policies. Such algorithms require iteration and cannot be expressed by standard database queries, but they can be implemented using recursive queries, that iterate computing routing updates until no more changes are produced. Traditional database techniques for incremental view maintenance do not work well on recursive queries but are fully supported by DDlog. A performant incremental approach for control planes must gracefully handle such recursive fixpoint computations.

Incrementally programmed networked systems reflect these difficulties. A developer today must explicitly identify incremental changes, and the code's complexity makes it difficult to understand, to update, or to confirm an update's success. It is also difficult to test, since many code paths are only exercised when a deployment takes a particular series of steps to arrive at a given configuration.

The rise of data plane programmability raises additional issues, but also introduces a potential mechanism to address the above control plane challenges. Network devices now expose low-level packet processing logic to the control plane through a standardized API. Some embodiments leverage the data plane APIs and programming languages when writing the control plane. Examples of data plane languages that are commercializing programmable switching ASICs (application-specific integrated circuits) include Broadcom's Trident-4 and Jericho-2 that are programmable using NPL, and Intel/Barefoot's Tofino and Cisco's Silicon One that support P4.

The execution of programmable data planes is driven by policies created by the control plane. These policies are encoded into table entries written by the control plane and read by the data plane. These table entries generalize traditional forwarding table entries and can encode a rich set of policies (e.g., forwarding, load-balancing, firewall rules, encapsulation and decapsulation, etc.). A helpful perspective can conceptualize a data plane table as a database view reflecting the part of the global control plane state that is relevant to the controlled device. For example, the forwarding table entries of a switch are the entries from the global controller routing table describing the links connected to the switch. When conceived this way, programming data plane policies becomes a traditional incremental view maintenance problem. This is exactly the problem solved by an incremental control plane: automatically computing changes to views based on changes in the database.

Some embodiments address the scalability challenges of the control plane by providing an control plane that executes in an incremental fashion. These embodiments leverage the data plane APIs and programming languages when writing the control plane, in order to solve the difficulties of incremental operation of the control plane.

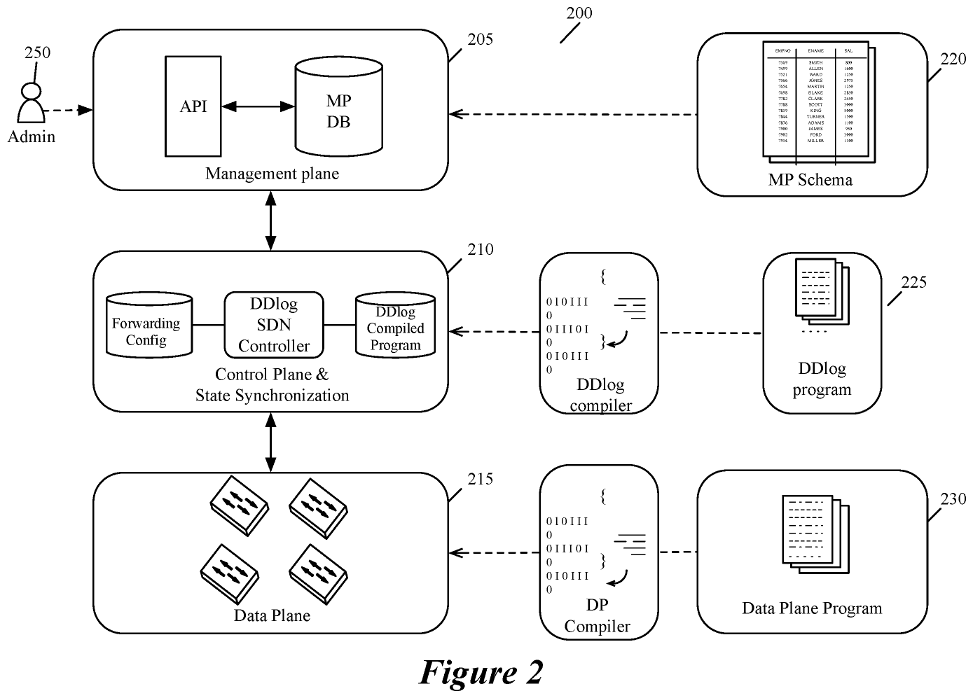

FIG. 2 illustrate an SDN stack 200 of some embodiments of the invention. As shown, this stack includes a management plane 205, a control plane 210 and a data plane 215. In some embodiments, the management plane (MP) is implemented by a cluster of one or more network SDN managers (servers), the control plane (CP) is implemented by a cluster of one or more network SDN controllers (servers), and the data plane (DP) is implemented by one or more software or hardware forwarding elements (e.g., software or hardware switches and routers) and/or software or hardware middlebox elements (e.g., firewalls, load balancers, etc.).

In some embodiments, the MP servers (also called SDN managers) interact with network administrators to receive data to define network elements, such as managed switches and routers (e.g., logical switches and routers), and to define forwarding policies and service policies (e.g., middlebox service policies) associated with these network elements. The CP servers (also called SDN controllers) receive the network element data defined in the MP servers, and based on this data define configuration data for configuring the network elements (e.g., the switches and routers) in the DP to implement the network elements (e.g., the switches and routers) defined in the management plane.

The SDN stack 200 provides a unified environment for programming the entire network, and provides network developers with correctness and scalability guarantees. Relational database abstractions are used to model management plane entities and the data plane tables. A fully and automatically incremental control plane program sits between them. These relations are used in rules that define how data plane table entries are computed from management plane policies. The network developer can thus write a fully type-checked program that spans the entire network.

The SDN programming framework 200 coordinates three different sets of programs, with one program set per network plane, i.e., a first set of one or more programs 220 for the management plane 205, a second set of one or more programs 225 for the control plane 210 and a third set of one or more programs 230 for the data plane 215. A system administrator 250 configures the management plane 205 by populating and modifying the contents of a database instance. The database schema represents the network's structure and policies. Tables are created for network links, network devices (e.g., switches, interfaces, virtual machines), high-level administrative structures (e.g., administrative domains), security policies, and more. In some embodiments, the management plane uses an OVSDB schema.

The control plane 210 is driven by two different kinds of input relations: (1) relations representing the current network configuration, obtained from the management database and (2) relations representing notifications from data plane packets and events. The control plane computes output relations, which correspond to tables in the managed data planes. The control plane is a DDlog control plane. As such, this incremental control plane 210 only computes changes to output relations given changes to input relations.

In some embodiments, the controller is in charge of state synchronization and installs the data from the controller output relations as entries in the programmable data plane tables. To interface between these software programs, the SDN stack 200 generates the code that orchestrates data movement between planes. This automates tasks that previously required writing code that “glues” the different sets of programs of the different planes.

In some embodiments, the control plane's DDlog schema (for the relations for the control plane) is generated from the schemas of the management plane and the data plane program tables. The controller reads changes from the management plane and transforms them to inputs to the set of programs for the control plane. When the controller receives a message from the data plane, it transforms the message into a row insertion into an input relation. This input relation's contents can also influence the controller's behavior, forming a feedback loop. In the type-generation and compilation processes, the SDN stack's checks the types of the data definitions and database schema, ensuring that only well-formed messages are exchanged.

As further described below, for the SDN stack 200 of some embodiments, a network programmer provides the data schema (e.g., OVSDB schema) for the management plane, the DDlog programs for the control plane, and data plane programs (e.g., P4 programs) for the data plane. OVSDB is used by some embodiments for the MP data schema, because OVSDB is well-suited for state synchronization, as it can stream a database's ongoing series of changes, grouped into transactions, to any interested party.

Some embodiments use DDlog to implement a centralized control plane. Each data plane in some embodiments has a synthesized local control plane that programs tables on the data plane's local device (e.g., on the forwarding ASIC (application specific integrated circuit) of the hardware switch or router) and relays events to the centralized control-plane using the data plane's runtime API (e.g., the P4Runtime API). DDlog has several key properties that improve on past incremental and relational languages. These include (1) streaming APIs for performance, (2) types for correctness, and (3) procedural language for expressivity.

At runtime, a DDlog control-plane program accepts a stream of updates (e.g., from OVSDB) to input relations—inserts, deletes, or modifications. It produces a corresponding stream of updates to the computed output relations. The DDlog CP program changes are also grouped into transactions. These maintain important policy invariants and are much easier to reason about than events or database triggers.

DDlog's powerful type system includes Booleans, integers and floats, and data structures like unions, vectors, and maps. These can be stored in relations and manipulated by rules. DDlog can perform many operations directly over structured data, including the full relational algebra. Rules can include negation (like SQL “EXCEPT”), recursion, and grouping. DDlog also has a powerful procedural language that can express many deterministic computations, used in more complex network features.

As mentioned above, some embodiments use P4 to program the data plane. P4 has emerged as one of the preferred language for data plane programming with a robust and growing ecosystem. In particular, the P4Runtime API specifies how the control plane can control the elements of a P4-defined data plane. Some embodiments assume a single P4 program for all network devices, while other embodiments support a network with multiple classes of devices (e.g., spine, leaf switches), each running a different P4 program. The management plane relations reflect these various classes.

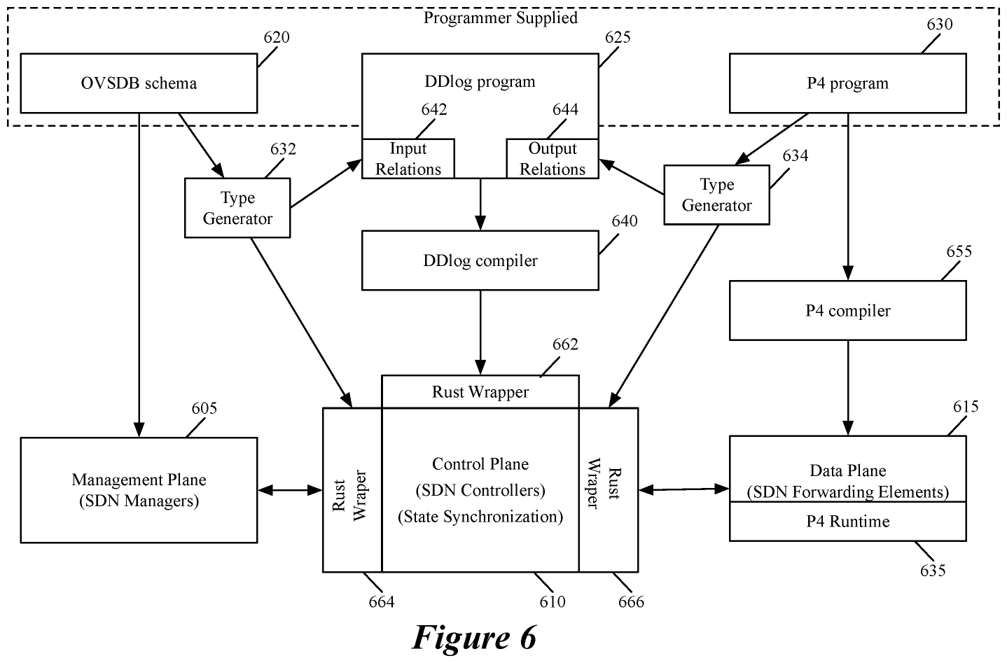

As further described below by reference to FIG. 6, some embodiments use Rust for code needed for SDN controller and state synchronization pieces. Rust's low-level control and memory safety fit the goals of the SDN stack 200. It can also be easily linked against existing Java or C++ programs. The DDlog CP programs are also compiled to Rust by the DDlog compiler. Some embodiments build and use the Rust libraries as interfaces between the controller and the management plane and P4Runtime of the data plane.

Data exchange between the different planes requires an intermediate data representation. The control plane 210 in some embodiments reads input changes from the management plane 205 and writes output changes to the data plane 215. The data plane 215 also sends notifications to the control plane 210, e.g., sends data regarding MAC addresses learned in the data plane. In some embodiments of the SDN stack 200, changes from the management plane are represented by changes in OVSDB state.

Also, communication between the control plane 210 and data plane 205 in some embodiments uses the P4Runtime API as mentioned above. A packet digest can be used to send notifications to the control plane 210 from the data plane, and control plane output changes can modify entries in the match-action tables in the data plane 215.

Since all communication flows through the control plane 210, the relations of the CP DDlog serve as the natural intermediate data representation. In some embodiments, the SDN stack's tooling generates an input relation for the controller for each table in the OVSDB management plane, and generates a controller input relation for each packet digest in the P4 program. An output relation for the controller is generated for each match-action table in the P4 controlled data plane 215. Also, generated helper functions in Rust convert data between P4Runtime and DDlog types in some embodiments. This approach enables co-design of the control plane and data plane and a close integration between the two.

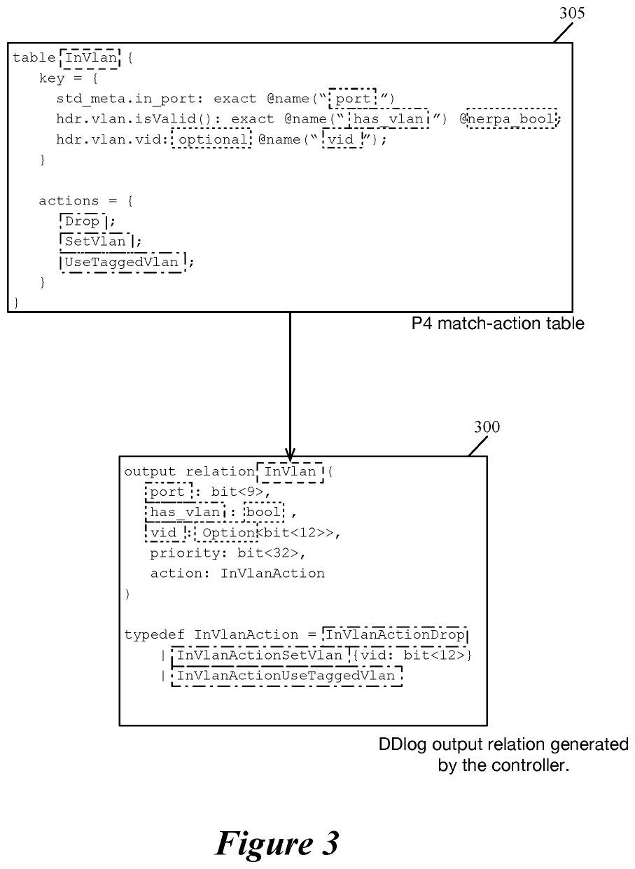

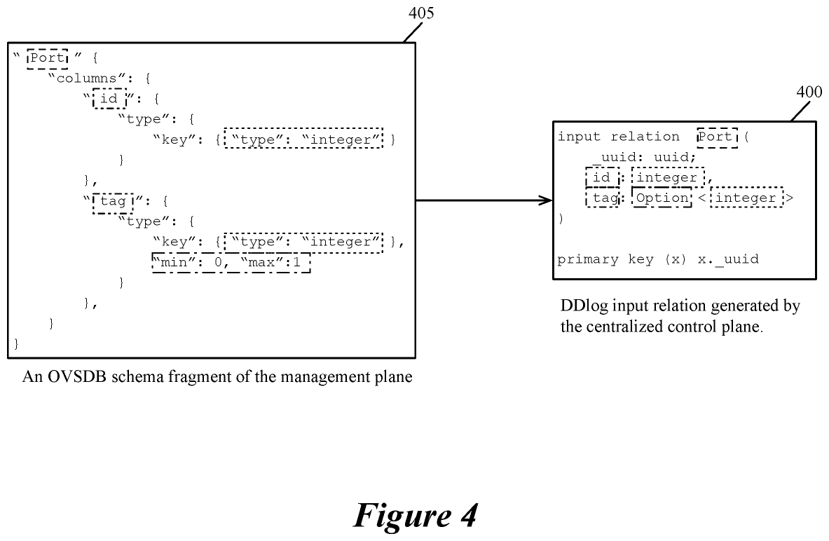

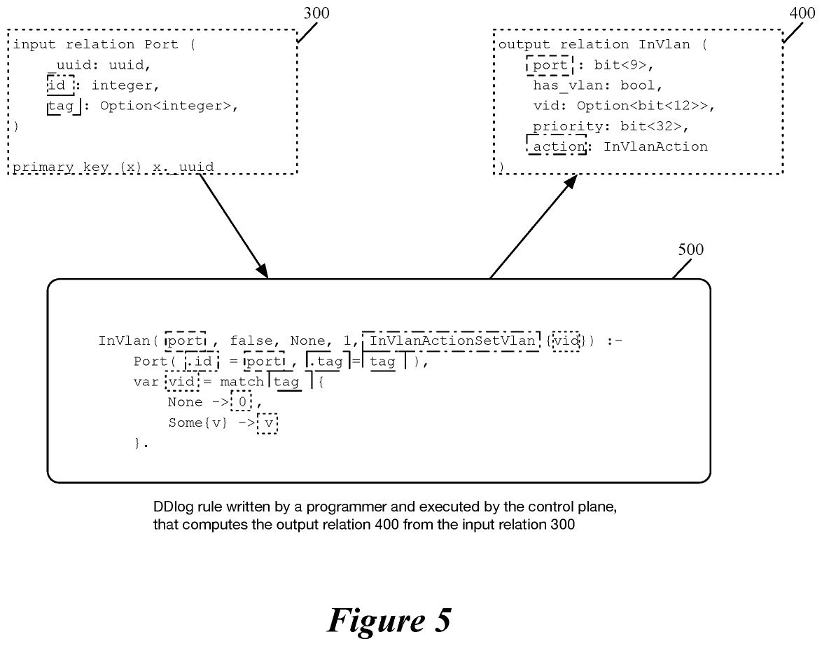

FIGS. 3-6 illustrate examples of how code snippets present a simplified version of a VLAN assignment, and illustrate how programs for the three different planes 205, 210 and 215 fit together cohesively. FIG. 3 illustrates the declaration of the output relation InVlan 300 that is generated from a P4 match-action table 305, while FIG. 4 illustrates that the input relation Port 400 that is generated from an OVSDB table 405. FIG. 5 illustrates a DDlog rule 500 that a programmer writes to compute the contents of the output relation 400 from the data in the input relation 300. In FIGS. 3-5 corresponding constructs in the different planes are designated by similar dashed-lines.

Some embodiments provide a programming framework to build programmable networks based on the SDN stack 200. This framework is referred to as Nerpa, Network Programming with Relational and Procedural Abstractions. This framework enables a new methodology for building programmable networks. Nerpa automates many aspects of the process of programming the network stack. To aid correctness, it ensures type safety across the management, control, and data planes. To improve scalability, it uses an incremental control plane that recomputes state in response to network configuration changes.

To address correctness, Nerpa pairs a DDlog control plane with a P4 data plane to write a complete type-checked program. This provides more obvious correctness than an OpenFlow-like data plane. While the latter has some structure, it is not apparent to the controller, which just generates program fragments. To address scalability, a programmer can write a Nerpa control plane in DDlog, which as mentioned above uses a declarative language with a fully and automatically incremental implementation.

FIG. 6 illustrates a Nerpa programming framework 600. As shown, this framework includes a management plane 605, a DDlog control plane 610 and a P4 data plane 615. In some embodiments, the management plane 605 is implemented by a cluster of one or more network SDN managers (servers), the control plane 610 is implemented by a cluster of one or more network SDN controllers (servers), and the data plane 615 is implemented by one or more software or hardware forwarding elements (e.g., software or hardware switches and routers) and/or software or hardware middlebox elements (e.g., firewalls, load balancers, etc.).

As shown in FIG. 6, a Nerpa programmer supplies three files, which are an OVSDB schema 620, a DDlog program 625, and a P4 program 630. The OVSDB schema 620 defines the management plane constructs for the management plane, the DDlog program 625 has rules that define the control plane, and the P4 program 630 provides the rules for implementing the data plane.

A system administrator configures the management plane by populating and modifying the contents of an OVSDB instance. Its schema represents the high-level structure of the network. The control plane 610 is defined by the DDlog program 625 that computes a set of output relations from the contents of some input relations. The DDlog program has two kinds of input relations: (1) a first kind representing the current network configuration, synchronized from the management database and (2) a second kind representing notifications from data plane packets and events. The control plane output relations correspond to entries for P4 tables.

The programmer can implement the control plane program to compute the output relations as a function of the input relations. As shown, type generators 632 and 634 generate the input and output relations 642 and 644 from the data types provided through the OVSDB schema and P4 program. As shown, these generators also generate the Rust data types for the Rust wrappers 664 and 666 to allow the runtime control plane 610 (i.e., the controller cluster) to communicate with the runtime management plane 605 (i.e., the SDN manager cluster) and the runtime data plane 615 (i.e., the switches and routers that implement the data plane).

The DDlog compiler compiles the DDlog program into the compiled control plane 610. A DDlog compiler 650 automatically makes the computation of the output relations from the input relations an incremental process. The data plane 615 is programmed using P4. The data plane is implemented by one or more forwarding elements (e.g., one or more switches and routers), as described above. The controller that implements the control plane 610 in some embodiments uses the P4Runtime API 635 to install DDlog output relations as table entries in the P4-enabled switch.

To interface between the Nerpa programs, Nerpa automates many tasks that previously required writing glue code, by generating the code that orchestrates the data movement between the planes. For instance, DDlog input and output relations are generated from the OVSDB schema and the P4 program by the type generators 632 and 634. The Nerpa controller reads changes from OVSDB and transforms them to inputs to the DDlog program. It also transforms DDlog outputs into P4 table entries, and writes those entries to the switch using the P4Runtime API 635. When the P4 program sends a digest back to the Nerpa controller, the controller transforms it into input to a DDlog relation with content that can also influence the controller's behavior, forming a feedback loop. In the type-generation and compilation processes, Nerpa typechecks the data definitions and ensures that only well-formed messages are exchanged.

In some embodiments, the “glue” interface between all these services of the different planes (i.e., management, control and data planes) are written in Rust as shown in FIG. 6. Rust's low-level control and memory safety fit Nerpa's goals well. In some embodiments, DDlog compiler 640 compiles the DDlog programs into a Rust format 662. Some of these embodiments also use Rust libraries to interface with OVSDB and P4Runtime. The OVSDB Rust library in some embodiments uses the Rust bindgen create to generate Rust foreign-function interface bindings to OVSDB's C codebase. The P4Runtime Rust library in some embodiments uses the P4Runtime Protocol Buffer definition files to generate Rust code for the API calls. It then exposes an end user friendly API. Both libraries are included in a Nerpa repository in some embodiments.

Data exchange between the different planes need an intermediate data representation. The control plane in some embodiments reads input changes from the management plane and writes output changes to the data plane. The data plane can also send notifications (e.g., for MAC learning) to the control plane. In the Nerpa implementation of some embodiments, changes from the management plane are represented by changes in OVSDB state. Communication between the control plane and data plane in some embodiments uses the P4Runtime API. Also, in some embodiments, a packet digest can be used to send notifications to the control plane over the Stream RPC, while output changes modify entries in the match-action tables using the Write RPC.

Since all communication flows through the control plane, DDlog relations serve as the natural intermediate data representation. To represent inputs from the management plane, some embodiments used ovsdb2ddlog, a tool which generates DDlog relations from an OVSDB schema. Some embodiments implement p4info2ddlog, a tool to generate DDlog relations from a P4 program. This tool consumes the “P4info” binary file that is produced by a p4 compiler 655 that compiled the P4 program into a format for consumption by the data plane forwarding elements. The P4info bindary file describes the tables and other objects in the P4 program. From this file, p4info2ddlog tool generates an input relation for each packet digest and an output relation for each match-action table. It also generates helper functions in Rust to convert data between P4Runtime and DDlog types. This approach enables codesign of the control plane and data plane and a close integration between the two.

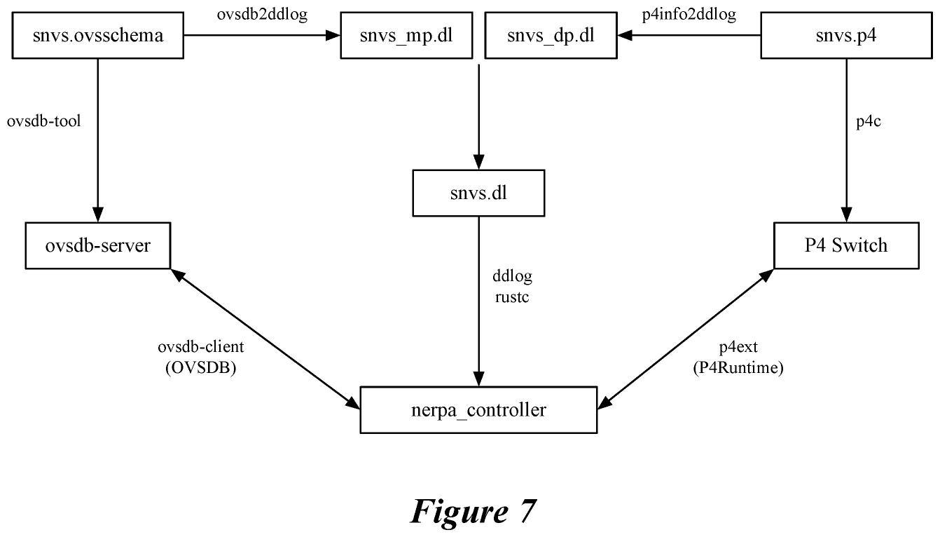

FIG. 7 illustrates an exemplary Nerpa implementation. This example is for a simple network virtual switch (SNVS) that implements several important networking features, including VLANs, MAC learning, and port mirroring, and executes all layers of the stack, using OVSDB, the DDlog runtime, and the P4 switch. In this example, the components shown with solid lines are programs written as part of Nerpa, while the components shown with dashed lines are external programs used by the Nerpa programs.

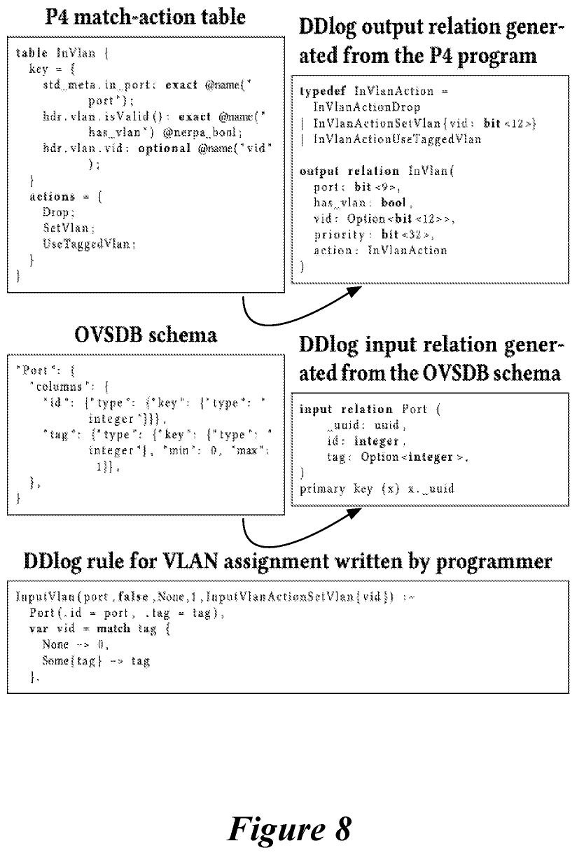

FIG. 8 illustrates the code snippets that implement a simplified version of the VLAN assignment feature. This example shows how the Nerpa pieces fit together. As shown, a DDlog output relation 810 is generated from a P4 match-action table 805 and a DDlog input relation 820 is generated from an OVSDB table 815. A Datalog rule 825 then derives the output relation from the input relation.

As described above, Nerpa uses relational and procedural abstractions to improve the correctness and scalability of network programs. It uses OVSDB and the DDlog data representation in the relational, incrementally programmed control plane. It uses the imperative data plane program, written in P4.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

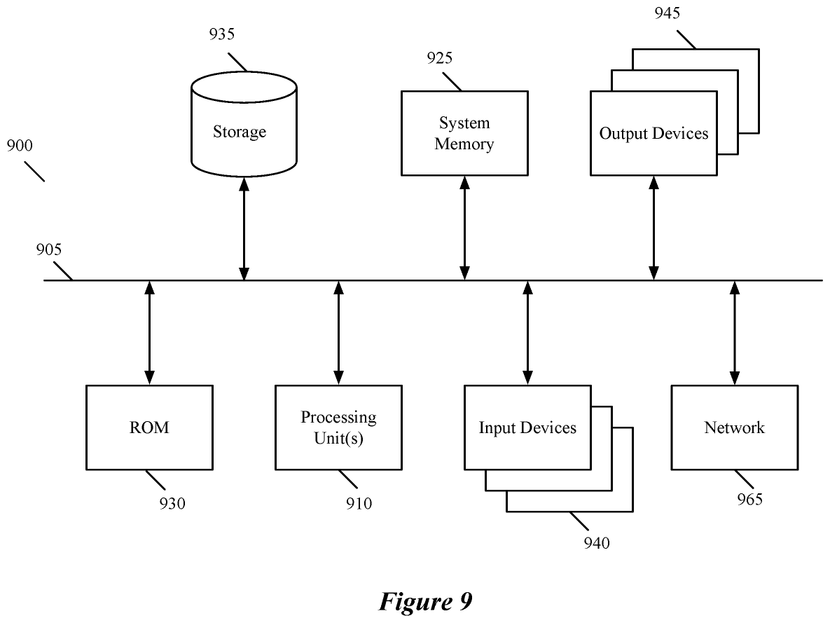

FIG. 9 conceptually illustrates a computer system 900 with which some embodiments of the invention are implemented. The computer system 900 can be used to implement any of the above-described computers and servers. As such, it can be used to execute any of the above described processes. This computer system includes various types of non-transitory machine readable media and interfaces for various other types of machine readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. The read-only-memory (ROM) 930 stores static data and instructions that are needed by the processing unit(s) 910 and other modules of the computer system. The permanent storage device 935, on the other hand, is a read-and-write memory device. This device is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a flash drive, etc.) as the permanent storage device. Like the permanent storage device 935, the system memory 925 is a read-and-write memory device. However, unlike storage device 935, the system memory is a volatile read-and-write memory, such a random access memory. The system memory stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices enable the user to communicate information and select commands to the computer system. The input devices 940 include alphanumeric keyboards and pointing devices (also called “cursor control devices”). The output devices 945 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 9, bus 905 also couples computer system 900 to a network 965 through a network adapter (not shown). In this manner, the computer can be a part of a network of computers (such as a local area network (“LAN”), a wide area network (“WAN”), or an Intranet, or a network of networks, such as the Internet. Any or all components of computer system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A software defined network (SDN) stack for performing network operations in a datacenter, the SDN stack comprising:
a management plane (MP) for interacting with a network administrator to identify network elements to deploy in the network and to receive policies associated with the identified network elements;
a data plane (DP) comprising one or more managed forwarding elements that are configured to implement the network elements identified by the management plane;
a control plane (CP) for configuring the managed forwarding elements of the data plane, by mapping input MP data constructs to output DP data constructs, wherein the control plane is an incremental control plane that computes changes to output DP data constructs based on changes to the input MP data constructs.

2. The SDN stack of claim 1, wherein the incremental control plane executes a Differential Datalog (DDlog) process to map the MP data constructs to the output DP data constructs in an incremental manner.

3. The SDN stack of claim 2 further comprising a type generator that generates an input relation for the control plane from a MP data schema fragment, and generates an output relation for the control plane from a match-action table entry of the data plane, wherein the control plane has a rule to map the generated input relation to the generated output relation.

4. The SDN stack of claim 3, wherein the control plane communicated with the data plane through a runtime API of the data plane.

5. The SDN stack of claim 4, wherein the runtime API is a P4 runtime API.

6. The SDN stack of claim 4, wherein the control plane communicates with the DP runtime API through a Rust interface.

7. The SDN stack of claim 3, wherein the management plane uses an OVSDB (Open vSwitch Database) schema, and the control plane during runtime accepts stream of updates to MP data constructs that are mapped to CP input relations.

8. The SDN stack of claim 7, wherein the stream of updates include insert, delete and modification operations to the MP constructs.

9. The SDN stack of claim 7, wherein the control plane communicates with the management plane through a Rust interface.

10. The SDN stack of claim 7, wherein for the generated CP input relations, the control plane produces a corresponding stream of updates to the generated output relations.

11. A method of programming network operations in a software defined network (SDN), the method comprising:
receiving, through a management plane (MP), data for defining network elements in the SDN and policies associated with the identified network elements;
mapping, in a control plane (CP) that configures managed forwarding elements of a data plane (DP), input MP data constructs to output DP data constructs, said mapping comprising incrementally computing changes to output DP data constructs based on changes to the input MP data constructs.

12. The method of claim 11, wherein the mapping comprising using a Differential Datalog (DDlog) process to map the MP data constructs to the output DP data constructs in an incremental manner.

13. The method of claim 12 further comprising
generating input relations for the control plane from MP data schema fragments;
generating output relations for the control plane from match-action table entries of the data plane; and
using control plane rules to map the generated input relations to the generated output relations.

14. The method of claim 13 further comprising using a runtime API of the data plane for control plane and data plane communications.

15. The method of claim 14, wherein the runtime API is a P4 runtime API.

16. The method of claim 13 further comprising using a Rust interface for control plane and data plane communications.

17. The method of claim 13 further comprising using an OVSDB (Open vSwitch Database) schema for the management plane, and configuring the control plane to accept during runtime streams of updates to MP data constructs that are mapped to CP input relations.

18. The method of claim 17, wherein the stream of updates include insert, delete and modification operations to the MP constructs.

19. The method of claim 17 further comprising using a Rust interface for control plane and management plane communications.

20. The method of claim 17, wherein for the generated CP input relations, the control plane produces a corresponding stream of updates to the generated output relations.
